(19) United States
(12) Patent Application Publication
(10) Pub. No.: US 2008/0224369 A1
(43) Pub. Date: Sep. 18, 2008

(54) Sheathing for a Suspension Spring

(75) Inventors: Frederic Barraja, Milon La Chapelle (FR); Laurent Urrutia, Montigny Le Bretonneux (FR)

Correspondence Address: OBLON, SPIVAK, MCCLELLAND MAIER & NEUSTADT, P.C., 1940 DUKE STREET, ALEXANDRIA, VA, 22314, US

(73) Assignee: Renault s.a.s., Boulogne Billancourt (FR)

(21) Appl. No.: 12/089,612

(22) PCT Filed: Sep. 28, 2006
(86) PCT No.: PCT/FR06/50956

§ 371 Date: Apr. 14, 2008

(30) Foreign Application Priority Data
Oct. 13, 2005 (FR) 0553111

(51) Int. Cl. F16F 1/12

(52) U.S. Cl. 267/172

(57) ABSTRACT

A suspension assembly of a motor vehicle including a suspension spring, a sheathing to be placed on a portion of at least an end coil of the suspension spring, a center cup on which the sheathed end of the suspension spring is placed, a mechanism for indexing the angular position of the sheath with regard to the centering cup, and a mechanism for indexing the angular position of the suspension spring with regard to the sheath.

The present invention relates to sprung suspension systems for motor vehicles and relates more specifically to the sheathing devices used on the springs therefore.

What happens is that the end coil of such springs, which coil is generally positioned on a centering cup, is exposed, where it makes contact with said cup, to corrosion connected with the buildup of water and/or of debris in this region. What is more, the rubbing of said end coil against the centering cup may give rise to irritating noise: it is therefore known practice for the end coil of such a spring to be sheathed, at least on its part that is in contact with the centering cup, this being both to protect it from corrosion and to limit the noise caused by rubbing or vibration.

Document FR 2 840 966 thus proposes, for example, a sheath for part of the end coil of a helical suspension spring of which the opening, situated on the interior periphery, allows said end of said spring to be protected from the buildup of debris and of water which cause the onset of corrosion. The sheath proposed in document FR 2 840 966 further comprises radial and axial spacing means so that the suspension spring can be centered repeatably on its cup.

In such a device, however, the angular positioning of the end coil, and therefore of the spring, in the sheath is not fixedly defined. Furthermore, once the spring has been placed in the sheath, the angular position of the whole in the centering cup is not defined either. One particular result of this is that the direction of the resultant of the forces exerted by the helical suspension spring with respect to the axis of said spring is inconsistent: in particular, said resultant is not generally directed precisely along the axis of said spring, and this may cause parasitic forces to be exerted on the vehicle axle assembly and, for example, cause said vehicle to oversteer.

One object of the invention is a device that allows the suspension spring to be given a repeatable angular position in its sheath and on its centering cup and to allow the whole to be easy to assemble.

The invention achieves its objective by virtue of a motor vehicle suspension assembly comprising a suspension spring, a sheath intended to be positioned over at least part of the end coil of the suspension spring, and a centering cup on which the sheathed end of the suspension spring is positioned, characterized in that the sheath and the centering cup include appropriate means for indexing the angular position of the suspension spring with respect to the centering cup.

Advantageously, the appropriate means comprise a first set of means to index the angular position of the sheath with respect to the centering cup and a second set of means to index the angular position of the suspension spring with respect to the sheath.

Advantageously, the first set of means includes a male element able to collaborate with an appropriate complementary female element, the male and female elements being positioned on the sheath and on the centering cup respectively, or on the centering cup and on the sheath, respectively.

In a preferred embodiment of the invention, the male element of the first set of means is a lug able to collaborate with at least one appropriate complementary hole, and the second set of means consists of an end stop positioned on the sheath.

Further features and advantages will become apparent from reading the description which follows, with reference to the attached drawings in which:

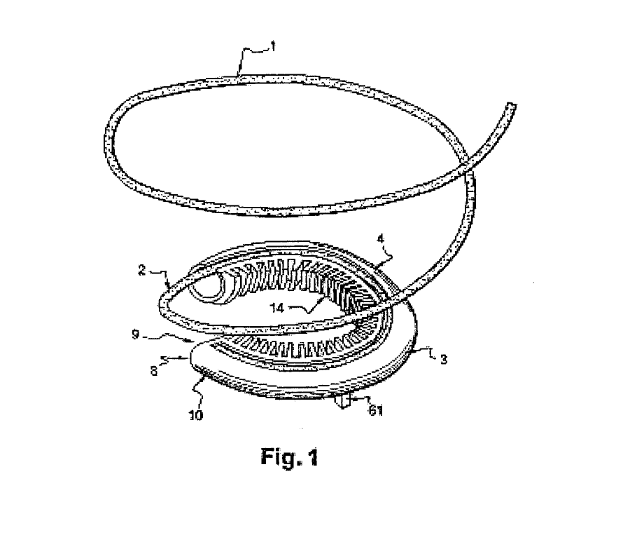

FIG. 1 is a schematic perspective view of the end coil of a suspension spring and of the sheath of a device according to the invention;

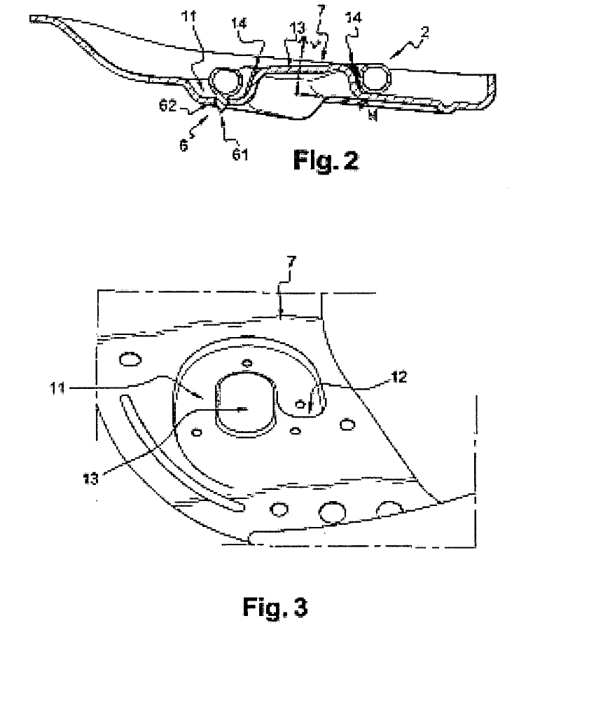

FIG. 2 is a schematic sectioned view of the end coil of the spring and of the sheath of a preferred embodiment of the invention;

FIG. 3 is a depiction of a centering cup according to one embodiment of the invention.

FIG. 1 schematically shows the end part and the end coil 2 of a suspension spring 1, and an appropriate housing 4 containing the sheath 3 into which at least part of the end coil 2 is inserted.

In the suspension device according to the invention, the angular position of the suspension spring 1 is indexed with respect to the centering cup 7 by appropriate means. These means comprise, on the one hand, a first set of means 6 for indexing the angular position of the sheath 3 with respect to the centering cup 7 and, on the other hand, a second set of means 8 for indexing the angular position of the suspension spring 1 with respect to the sheath 3.

In a preferred embodiment of the invention, the appropriate means 6 for indexing and repeatably setting the angular position of the sheath 3 with respect to the centering cup 7 include at least one male element 61 positioned on the sheath 3 (or on the centering cup 7) and able to collaborate with an appropriate complementary female element 62 positioned on the centering cup 7 (or on the sheath 3). In the embodiment depicted in the figures, the male element 61 is a lug secured to the sheath 3 and able to collaborate by way of example by clip-fastening with an appropriate complementary hole 62 positioned on the centering cup 7. In alternative embodiments of the invention, this lug 61 may be positioned on the centering cup 7, said complementary hole 62 then being positioned on the sheath 3. To make assembly easier, the end of said lug 61 preferably has a conically tapered shape.

The second set of means 8 for indexing the angular position of the spring 1 with respect to the sheath 3 consists, in the preferred embodiment shown in the figures, of an end stop 9 positioned at one end 10 of the sheath 3 housing 4 in which at least part of the end coil 2 of the spring 1 is inserted.

As depicted in FIG. 3, the centering cup 7 includes, on its upper face, namely on the face against which the spring is to rest, a pressing 11 of substantially circular shape, forming a hollow part capable of accommodating the sheath 3 worn by the spring 1. The depth of the pressing varies continuously over the entire circumference of the pressing so that the incline thus formed can collaborate over the entire length with the sheath 3 and the end coil 2 of the spring 1. Thus, the deepest part of the pressing 11 forms a stop means 12 for the end 10 of the sheath 3.

A boss 13 is thus formed inside the substantially circular shape of the pressing 11. There are ribs 14 on the interior perimeter of the sheath 3 and these ribs have shapes capable of resting against the boss 13 of the cup 7. These ribs 14, which firstly improve the acoustics associated with friction, thus in the context of the invention help to index the sheath 3 with respect to the centering cup 7.

When the spring 1 and the sheath 3 are being assembled, the end stop 9 thus gives said spring 1 a defined and repeatable position in the sheath 3 housing 4 provided for this. Once the spring 1 and the sheath 3 have been assembled, the appropriate means 6 positioned in said sheath 3 and the centering cup 7 allow the relevant assembly line operator to position the “sheath 3/suspension spring 1” assembly in a set and repeatable position with respect to the centering cup 7. This in particular means that the direction of the resultant of the forces exerted by the suspension spring 1 will be consistent, this being something that is conducive to better behavior of the vehicle equipped with such a suspension device. The appropriate means 6 positioned on said sheath 3 and the centering cup 7 are made easier to mate with one another by the fact that the sheath 3 is guided in the incline formed by the pressing 11 and by the fact that part of the ribs formed on the sheath 3 collaborate with the boss 13 of the cup 7 and by the fact that the end 10 of the sheath 3 is butted against the stop means 12 formed in the pressing 11.

1-6. (canceled)

7. A motor vehicle suspension assembly comprising:
a suspension spring;
a sheath configured to be positioned over at least part of a coil of the suspension spring; and
a centering cup on which the sheathed end of the suspension spring is positioned, wherein the sheath and the centering cup include means for indexing an angular position of the suspension spring with respect to the centering cup.

8. The suspension assembly as claimed in claim 7, wherein the means for indexing includes a first set of means to index the angular position of the sheath with respect to the centering cup and a second set of means to index the angular position of the suspension spring with respect to the sheath.

9. The suspension assembly as claimed in claim 8, wherein the first set of means includes a male element positioned on the sheath and configured to collaborate with a complementary female element positioned on the centering cup.

10. The suspension assembly as claimed in claim 8, wherein the first set of means includes a male element positioned on the centering cup and configured to collaborate with a complementary female element positioned on the sheath.

11. The suspension assembly as claimed in claim 8, wherein the second set of means includes an end stop positioned at one end of the sheath housing into which at least part of the end coil of the spring is inserted.

12. A motor vehicle comprising a suspension assembly as claimed in claim 7.
